(19) United States
(12) Patent Application Publication
(10) Pub. No.: US 2007/0131603 A1
(43) Pub. Date: Jun. 14, 2007

(54) Effluent sterilizer system

(75) Inventors: Steven L. Kantor, Oshawa (CA); Douglas Norton, Whitby (CA); Denes Bernad, Toronto (CA)

Correspondence Address: WALKER & JOCKE, L.P.A., 231 SOUTH BROADWAY STREET, MEDINA, OH, 44256, US

(73) Assignee: Environmental Waste International, Inc., Ajax (CA)

(21) Appl. No.: 11/299,321

(22) Filed: Dec. 8, 2005

(51) Int. Cl. C02F 1/30

(52) U.S. Cl. 210/258; 210/257.1

(57) ABSTRACT

The present invention provides a system that utilizes microwave heating to sterilize contaminated effluent. The system sterilizes the contaminated effluent by heating it to a minimum temperature for a minimum duration under pressure, and then discharging it to a sanitary drain as sterilized effluent. The process maximizes energy efficiency by using a heat exchanger to raise the temperature of the contaminated effluent with heat drawn from the sterilized effluent of the previous batch. All solids and particles originally present in the contaminated effluent pass through the system and are discharged as part of the sterilized effluent.

### FIELD OF THE INVENTION

This invention relates to the sterilization of waste. In particular, this invention relates to a system for sterilizing contaminated effluent by heating it using microwave energy to a minimum temperature for minimum duration at a controlled pressure.

### BACKGROUND OF THE INVENTION

There has long been and continues to be a very significant need for effective means of destroying, sterilizing or otherwise neutralizing waste from a variety of industrial or institutional sources. In many instances, it is impractical or In the case of aqueous liquid waste where flow is more or less constant, it is undesirable and impractical to move these waste materials off-site for treatment. While there has and continues to be a number of means to heat waste water to the point of sterilization, most involve the use of steam heating and consume large amounts of energy to achieve these ends.

For instance, scientific study of new species of pathogens requires source control of these pathogens after study in laboratories to prevent their spread into the surrounding environment. As biological safety levels are refined, there becomes an increasing need to process wastewater from all streams leaving the laboratories. Such sources include showers, toilet flushes, sink drains, laboratory sinks, laboratory equipment, and autoclaves. Present systems are unable to process liquid and solid waste without screening out the solid material.

Recent published scientific work indicates that organisms suspended in water have a reduced tolerance to heat after exposure to microwave radiation.

While microwave treatment has been proposed as a method of dealing with such waste, systems have not become widely available which are secure against leakage, environmentally acceptable and economically reasonable. For example, the systems must be sealed against leakage at all steps of the process to prevent not only against leaking of pathogenic containing liquids but also of microwaves. The systems must also be cost and energy efficient. Thus it is necessary to apply an appropriate amount of microwave energy, for a suitable time period, for the amount of waste being treated.

Accordingly, there is a need for a system able to process liquid and solid waste to sterilize the waste. There is a further need for a system able to process liquid and solid waste that is energy efficient.

### SUMMARY OF THE INVENTION

The present invention provides a system that utilizes microwave heating, and resistance immersion heating coils, to sterilize biologically contaminated primarily liquid waste (“effluent”), which is essentially institutional sewage and wastewater from laboratory and greenhouse facilities (“contaminated effluent”). The sewage is initially ground in grinder pumps into particles less than a quarter inch in diameter. The process sterilizes the contaminated effluent by heating it to a minimum temperature for a minimum duration at a controlled pressure, and then discharges it to a sanitary drain as “sterilized effluent”. The process maximizes energy efficiency by using a heat exchanger to raise the temperature of the contaminated effluent with heat drawn from the sterilized effluent of the previous batch. The heat exchanger is designed to accommodate the residual particles in the ground sewage waste stream. All solids and particles originally present in the contaminated effluent pass through the system and are discharged as part of the sterilized effluent. The process is controlled and monitored by a programmable logic controller (PLC) and an array of instrumentation.

The preferred embodiment is accomplished by providing a system for A system for sterilizing contaminated liquid and solid effluent comprising an inlet for receiving the contaminated effluent, pumping means to move the contaminated effluent and sterilized effluent within the system, a pressurized heating vessel for sterilizing the contaminated effluent, comprising heating means for heating the contaminated effluent to a minimum temperature for a minimum duration, the heating means comprising a plurality of magnetron assemblies for directing microwave energy into contaminated effluent in the vessel, a heat exchanger for raising the temperature of the contaminated effluent with heat drawn from the sterilized effluent comprising a first side and a second side, where heat is exchanged as the contaminated effluent moves through the first side and the sterilized effluent simultaneously moves counter-current through the second side and no cross-contamination occurs between the contaminated effluent and the sterilized effluent during the heat exchange, pressurizing means to maintain a pressure in both the pressurized heating vessel and the second side of the heat exchanger that prevents boiling of the contaminated effluent and the sterilized effluent at the minimum temperature, and an outlet for discharging the sterilized effluent.

### BRIEF DESCRIPTION OF THE DRAWINGS

In drawings which illustrate by way of example only a preferred embodiment of the invention,

FIG. 1 is a schematic flow diagram of the system;

FIG. 2 includes views of a general assembly drawing of an embodiment of the system;

FIG. 3 includes views of a processing tank assembly drawing of an embodiment of the system;

FIG. 4 includes views of an auxiliary skid of an embodiment of the system; and,

FIG. 5 includes views of a heat exchanger assembly drawing of an embodiment of the system.

### DETAILED DESCRIPTION OF THE INVENTION

The present invention provides for the treatment of all waste including solid waste present in ordinary sewage. The sewage is ground by grinder pumps into particles less than a quarter inch in diameter. The ground sewage passes through a heat exchanger designed to accommodate this particle size in a waste stream. One particular use of the invention is in treating laboratory sewage where the effluent must be sterilized.

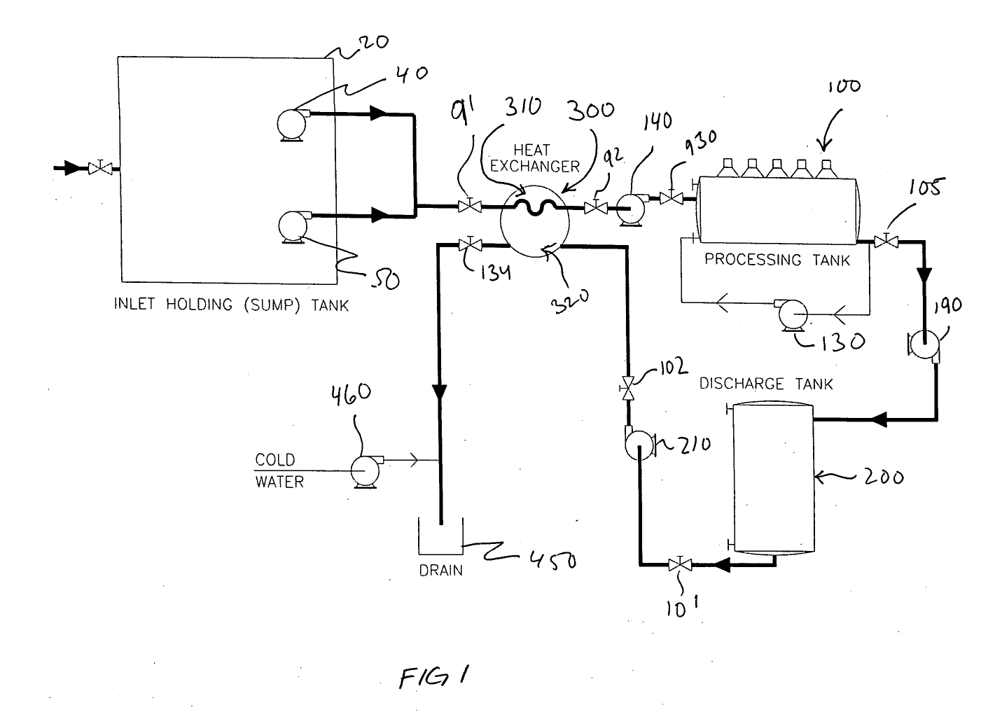

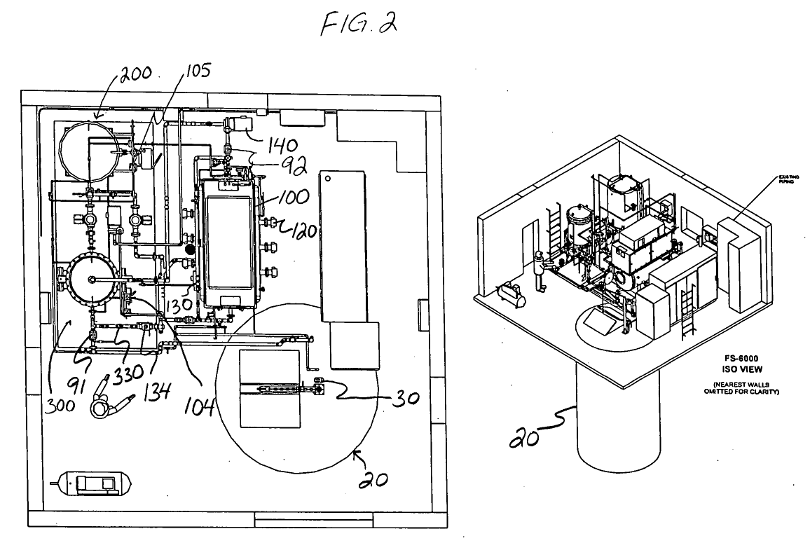

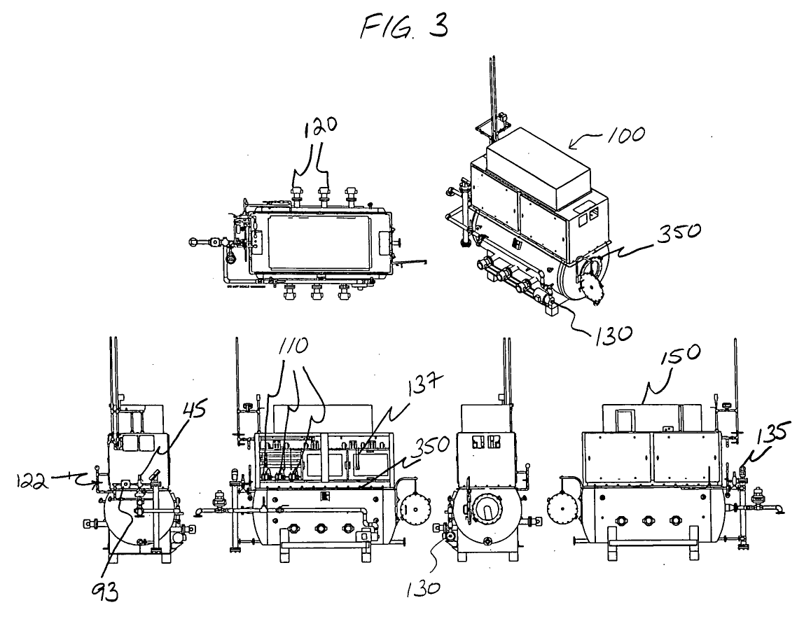

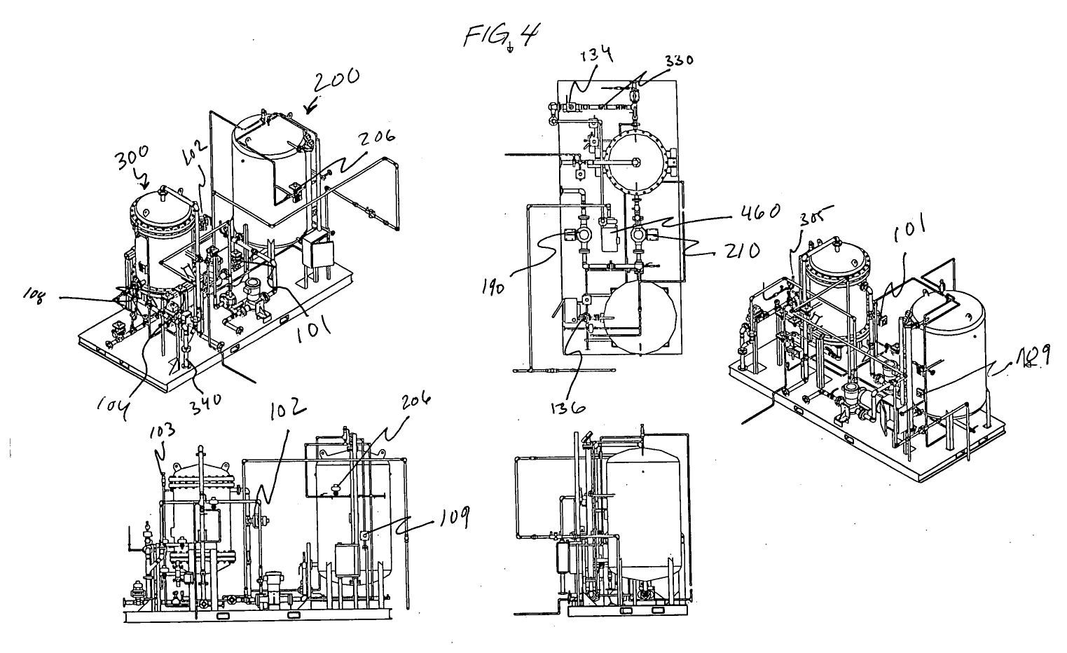

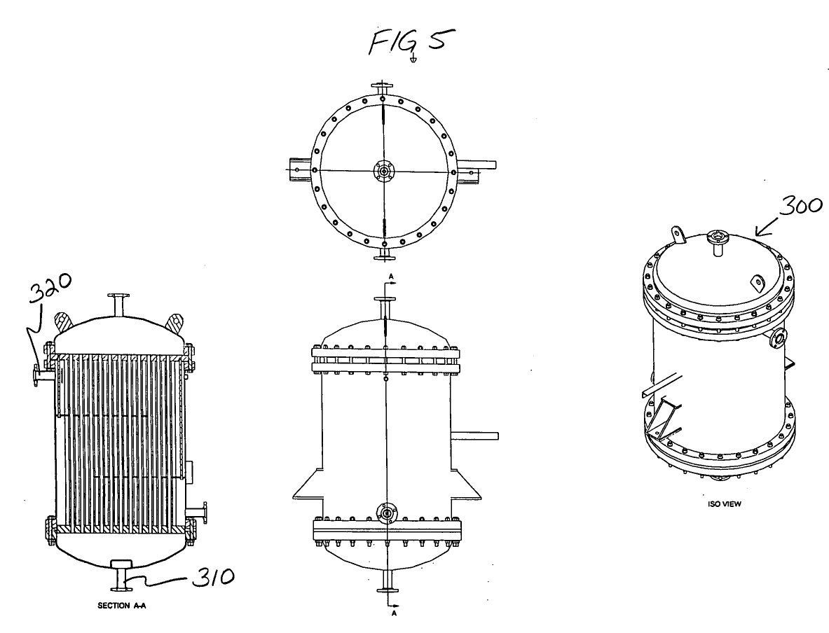

According to the preferred embodiment shown in FIGS. 1-5, the system contains five main groups of equipment: a processing tank subsystem, an auxiliary skid (which includes a heat exchanger 300, a discharge tank 200, an air compressor, instruments and pumps), the electrical/support group, a sump tank group, and a main air compressor and filters. These groups are all linked through a distributed control system, embodied in a programmable logic controller (PLC), that coordinates the functions of all components, to ensure the safe and efficient treatment of the contaminated effluent.

The processing tank subsystem includes a processing tank 100, used to sterilize the contaminated effluent, a recirculation pump 130, used to keep an even temperature in the processing tank 100, a booster pump 140, used to boost the contaminated effluent pressure into the processing tank 100, fourteen (14) magnetron assemblies 110 and six (6) resistance heaters 120, and an air conditioning unit 150. The subsystem also includes all relevant support equipment: thermocouple temperature sensors, flow switches, humidity and temperature sensors, a pressure transducer, a pressure gauge, a radar level sensor 135, microwave detectors 137, resistance heaters 120, band heaters 122, air operated valves, isolation valves, non-return valves, a flow meter, a pressure release valve, drain valves, a solenoid valve and a pressure sensor.

The auxiliary skid includes a discharge tank 200, a heat exchanger 300, pumps and all support equipment, instruments, and an air compressor. On its way to the processing tank 100, the contaminated effluent from the sump tank 20 flows through the heat exchanger's first side, namely tube side 310, where it gains heat from sterilized effluent flowing from the discharge tank 200 through the heat exchanger's second side, namely shell side 320. After the contaminated effluent has been processed in the processing tank 100, it flows to the discharge tank 200 located on this skid. The sterilized effluent remains there until it is pumped through the heat exchanger 300 to pre-heat the next incoming batch, losing heat to below the temperature required for discharge to the sanitary drain 450. The auxiliary skid also contains two pumps, a transfer pump 190 and a discharge pump 210 which are used in transferring the sterilize effluent through the system and all associated piping and valves, as well as mixing/dilution pump 460, required to mix cold tap water with the warm sterilized effluent, in case the exit temperature is above limit. The auxiliary skid also includes all relevant support equipment: thermocouple temperature sensors, pressure transducers, pressure gauges, a radar level sensor 136, air operated valves, isolation valves, non-return valves, pressure release valves, a proportional valve 134, pressure regulators, a back flow preventer, a globe valve, a drain valve, a static water mixer 340, instruments, and an air compressor. Compressed air is provided to pressurize the processing tank 100 and the discharge tank 200, as well as for the pressure test required for the heat exchanger 300.

The sump tank group includes the main in-ground sump tank 20, two grinder pumps 40 and 50 and radar level sensor 30. Contaminated effluent is collected and stored in the sump tank 20 prior to processing. Radar level sensor 30 is used by the PLC to calculate the fill level of the sump tank 20. At the beginning of a processing cycle, one of the two submersible grinder pumps 40 or 50 is used to grind and pump contaminated effluent. The sump tank subsystem also includes all relevant support equipment, namely isolation valves and non-return valves.

The electrical/support equipment group contains all electrical/control equipment, including the power supplies for the magnetrons, the PLC control system, the interface, all power and control wiring, and the electrical and control cabinet.

The system of the preferred embodiment also includes isolation valves, air operated valves and various filters (coalescing, particulate, exhaust HEPA). All actuated and proportional valves in the system fail automatically to the normally closed (N/C) position.

In the preferred embodiment, the contaminated effluent is sterilized by heating it to a minimum 285 degrees Fahrenheit (141 degrees Celsius) for at least 30 seconds. This is achieved in the processing tank 100 through the use of microwave heating and resistance immersion heating coils 120. In the preferred embodiment, fourteen 2,450 MHz magnetron assemblies 110 are used to produce the microwaves. As this temperature is above the boiling point of water at normal atmospheric pressure, a pressure of 60 PSI is maintained to prevent boiling in the processing tank 100, discharge tank 200 and the shell side 320 of the heat exchanger 300. The required system pressure is provided through a combination of vapour pressure from the effluent and the application of regulated compressed air.

Contaminated effluent is collected and stored in a sump tank 20. A radar level sensor 30 located in the sump tank 20 monitors the level of effluent in the sump tank 20. The system will not begin processing a batch unless there is sufficient effluent in the sump tank 20. The system leaves a minimum of 24 inches of effluent in the sump tank 20 at all times; this is the minimum required effluent to ensure proper pump cooling.

In the preferred embodiment, the system has two normal operating cycles:

1. Start-Up/Loading/Discharge—contaminated effluent is transferred from the sump tank 20, through the heat exchanger's tube side 310, into the processing tank 100, with sterilized effluent coming from the discharge tank 200, moving counter-current through the heat exchanger's shell side 320 at the same time as the contaminated effluent.

2. Sterilizing/Unloading—contaminated effluent is heated and sterilized in the processing tank 100 and then transferred to the discharge tank 200.

Apart from the initial start-up of the system or after a maintenance routine, the daily start-up condition will have a sterilized effluent load in the discharge tank 200. The last load of each day is normally left in the discharge tank 200 to be transferred through the heat exchanger 300 concurrently to the loading of the first batch of contaminated effluent the following day.

Cold, contaminated effluent from the sump tank 20 is loaded through the tube side of the heat exchanger 300, while at the same time the hot, sterilized effluent from the discharge tank 200 is pumped through the shell side 320 of the heat exchanger 300. The heat exchanger 300 has a dual purpose: it saves energy by pre-heating the contaminated effluent as it is loaded into the processing tank 100, and it cools the sterilized effluent. If temperature of sterilized effluent, sensed by temperature sensor 330, is still above the maximum allowed temperature (140 degrees Fahrenheit), it is diluted with cool tap water pumped through a static water mixer 340, with the help of the mixing/diluting pump 460.

The control system will balance flow across the heat exchanger 300 by monitoring the rate of change in tank levels in the processing tank 100 and discharge tank 200, and controls flow volume via the variable frequency drives on the effluent grinder pumps 40 and 50 and the discharge pump 210.

The control system includes safety interlocks, both mechanical and electrical, that prevent the process from continuing if the key subsystems or equipment are not functioning within acceptable parameters. As will be appreciated by the skilled worker, the use of such safety interlocks is well known in the art. An example of a mechanical interlock would be the door interlocks 350 on the processing tank comprising trip switches. An example of an electrical interlock would be a pressure measurement by a PLC that leads to the opening of a safety valve.

The control system employs cycles that control various functions. Each cycle executes a number of steps in a specific sequence to attain a state in which the machine can load, process and then discharge the effluent. The control system uses a number of operating parameters based on information collected throughout the system, such as level, temperature and pressure readings. These values are used to control the motors, pumps, valves, etc.

Various terms used to describe the operation of the control system are defined below:

A cycle is a set of instructions or steps that are followed in sequence by the PLC. Each cycle controls a different function within the operation of the machine. There are two primary operating cycles following the system start-up, i.e.: Loading/Discharge and Sterilization/Unloading. Each cycle is limited by a number of conditions or interlocks and will only run if these conditions are met.

A step refers to the specific instruction within a cycle. Only one step can be active while a cycle is active.

An interlock is a condition that must be met before a cycle is permitted to start or must be maintained while the cycle is operating. If one or more interlocks are not met while the cycle is operating, the cycle will either pause and wait for instructions from the operator, or will carry out recovery steps. Each cycle will have a set of specific interlocks. Any given interlock may be used by more than one cycle. In the preferred embodiment, system interlocks, which are a number of conditions grouped to form a single main interlock, are included to simplify troubleshooting.

An initial condition is a condition that must be met to initiate a cycle. This may include an operator initiation request. The initial conditions of some cycles do not include any operator interaction.

Recovery refers to how a cycle will resume operating if it has paused. A cycle will pause if one of the steps is unsuccessful, the cycle is aborted by the operator, or if an interlock is not met. Most cycles will allow the operator to resume at the step at which it was paused, or to reset the cycle back to an idle state. Other cycles will automatically execute a number of steps and then return to an idle state.

A cycle stop can be selected by the operator during any step in the operation of a cycle. The operator should only stop a cycle if it is necessary to adjust equipment before resuming the cycle.

There are two start-up situations:

1. At the beginning of regular daily operation, when the discharge tank 200 is full. A number of basic system checks (interlocks, faults, alarms) are performed automatically by PLC to ensure the process is ready to commence.

2. After a complete system shutdown (power off), when the discharge tank 200 is empty. A more thorough diagnostic check of all pumps and valves takes place. This situation generally occurs after maintenance on the unit, or after an emergency shutdown, that requires the discharge tank 200 to be emptied. If all equipment tests are completed without alarm, and there is enough effluent in the sump tank 20 to begin processing, the system can commence the Loading/Discharge Cycle.

Prior to starting the system, the operator conducts a visual inspection of the equipment and operating room to ensure there are no leaks. Once the operator manually starts the system, PLC takes over all operations. The PLC checks the fill status of the processing tank 100 and discharge tank 200. The radar level sensor 30 in the sump tank 20 is checked to make sure there is enough effluent for processing. Valve 91 between the sump tank 20 and the processing tank 100 is opened. Grinder pumps, 40 and 50, (alternating on daily loads) start. Booster pump 140 starts and valve 92 opens. Valves 101 and 102 open. Discharge pump 210 also starts. This creates flow on both the tube and shell sides of the heat exchanger 300. Valve 93 opens as required to regulate the pressure in the processing tank 100. Valve 103 opens if pressure in heat exchanger 300, monitored by pressure transducer 305, reaches a maximum set limit. The discharge pressure from the discharge tank 200 via the heat exchanger 300 is controlled using proportional valve 134. This and the speed of grinder pumps 40 or 50 and booster pump 140 are adjusted by the PLC to ensure equal flow on both sides of heat exchanger 300 and that the temperature of fluid discharge at the sanitary drain 450 does not exceed 140 degrees Fahrenheit. If temperature of sterilized effluent, sensed by temperature sensor 330, reaches a set maximum limit, the mixing/diluting pump 460 starts, mixing cold tap water in the effluent through the static water mixer 340. Pressure in discharge tank 200 is maintained at 65 PSI through air operated valve 206. Discharge pump 210 stops when sterilized effluent has been completely pumped out of discharge tank 200, and then all air operated valves between the discharge tank 200 and the sanitary drain 450 are closed. Grinder pumps 40 or 50 and booster pump 140 stop when the processing tank 100 reaches operating capacity. Valves 91, 92 and 93 close. This cycle is completed and will return to idle status. The discharge tank 200 is empty and the processing tank 100 is full. The Sterilizing/Unloading cycle will start automatically when this step is reached.

The Sterilizing/Unloading cycle sterilizes the contaminated effluent in the processing tank 100 by heating, using microwave generators and resistance heaters. The effluent is heated to minimum 285 degrees Fahrenheit and held for at least 30 seconds to ensure complete sterilization. Following sterilization, the effluent is pumped to the discharge tank 200. The cycle steps are as follows: the PLC confirms the fill status of the processing tank 100. The processing tank 100 is pressurized by opening air operated valve 104, with initial pressure set at 30 PSI. Resistance heaters 122 and band heaters 122 are turned on. Power supplies are turned on energizing their respective magnetrons. Recirculation pump 130 is turned on to circulate the fluid in the processing tank 100, creating a uniform heating of the contaminated effluent. The pressure in processing tank 100 nominally rises to 60 PSI during the heating process due to vapour pressure. The PLC monitors the pressure in processing tank 100 with a pressure transducer. Valves 103 and 104 are opened and closed as required, to regulate the pressure in the system. If the pressure rises above 60 PSI, the PLC operates air valve 103 to dump pressure back to the in-ground sump tank 20. At 70 PSI pressure, an alarm is issued and the resistance heaters 122 and the band heaters 122 are turned off. If pressure reaches 85 PSI, the pressure relief valve 45 dumps pressure back to the in-ground sump tank 20. During this step the Heat Exchanger Pressure Test Cycle is performed. When all thermocouple temperature sensors connected to the processing tank 100 nominally reach 285 degrees Fahrenheit, the cycle timer is started. If any thermocouple reading drops below this temperature, the cycle timer is reset and is started again when all readings have returned above 285 degrees Fahrenheit. The controller stays at this step until the cycle timer stays above this temperature for 30 seconds. When that occurs, the process cycle is completed and all power supplies and heaters are turned off. Recirculation pump 130 is also shut down. Valve 103 is closed. Sterilized effluent is transferred to the discharge tank 200 by opening valve 105. Valve 109 is also opened to allow a balance of pressure between the processing tank 100 and discharge tank 200. Transfer pump 190 is started to pump sterilized effluent from the processing tank 100 to the discharge tank 200. This step continues until the processing tank 100 registers as empty using the radar level sensor 135. Transfer pump 190 is stopped, and valves 105 and 109 between the processing tank 100 and discharge tank 200 are closed. Valve 104 controlling the compressed air intake of the processing tank 100 is also closed. The Sterilizing/Unloading Cycle is completed successfully and will return to idle status. The Loading/Discharge Cycle will start automatically when this step is reached, unless the operator has manually stopped the system, in which case the system pauses and awaits further command.

The Heat Exchanger Pressure Test is run during the Sterilizing/unloading Cycle. The test ensures that there is no leak between the hot & sterilized shell side 320 and the cold & contaminated tube side 310 of the heat exchanger 300. This is done by closing all valves leading into the heat exchanger 300, pressurizing the shell side 320, and then keeping track of the pressure on both sides of the heat exchanger 300. If there is any change of pressure, a leak is detected and an alarm is set. The cycle steps in the heat exchanger pressure test are as follows: all valves leading to/coming from heat exchanger 300 are closed. The shell side 320 of the heat exchanger 300 is pressurized to 90 PSI by opening valve 108. When 90 PSI is reached, valve 108 is closed. Pressure status timer is set for 30 minutes. During this time the controller keeps track of the pressure readings at the tube side 310 and the shell side 320 of the heat exchanger 300. If pressure readings at the tube side 310 and the shell side 320 remain the same for the duration of the test, the pressure test is successful and the cycle moves to the next step. If the reading at the shell side 320 is falling and reading at the tube side 310 remains constant, there is a valve leak on the discharge side. A minor alarm is set specifying that valve maintenance is necessary, and the cycle continues to the next step. If the reading at the shell side 320 is falling and the reading at the tube side 310 is rising, there is a leak through the heat exchanger 300 and containment has been lost. A major alarm is set, and the system performs an emergency shutdown. If the Heat Exchanger Pressure Test Cycle is completed successfully, the system will return to idle status.

If the Heat Exchanger Pressure Cycle is manually stopped by the operator, or any interlock condition is not met, the operator has the option to manually resume operation of the system. If the operator manually resumes operation of the system, the Heat Exchanger Pressure Test Cycle returns to the idle step until the initial conditions of the cycle are met. Note that a successful Heat Exchanger Pressure Test must be performed every cycle before the Processing Cycle can be run. If the cycle was cancelled before the test was completed successfully, the test must be run again before the system can continue processing the effluent.

If a major alarm has been triggered, such as a tube side 310 leak, the system immediately performs an emergency shutdown. An emergency shutdown describes any stoppage of equipment and processing that is not part of a normal cycle process. This includes stopping a cycle before completion and shutting the whole system down because of a fault or alarm. An emergency shutdown can be initiated by an operator or by the control program.

Various embodiments of the present invention having been thus described in detail by way of example, it will be apparent to those skilled in the art that variations and modifications may be made without departing from the invention. The invention includes all such variations and modifications as fall within the scope of the appended claims.

What is claimed is:

1. A system for sterilizing contaminated liquid and solid effluent comprising
an inlet for receiving the contaminated effluent,
pumping means to move the contaminated effluent and sterilized effluent within the system,
a pressurized heating vessel for sterilizing the contaminated effluent, comprising heating means for heating the contaminated effluent to a minimum temperature for a minimum duration, the heating means comprising a plurality of magnetron assemblies for directing microwave energy into contaminated effluent in the vessel,
a heat exchanger for raising the temperature of the contaminated effluent with heat drawn from the sterilized effluent comprising a first side and a second side, where heat is exchanged as the contaminated effluent moves through the first side and the sterilized effluent simultaneously moves counter-current through the second side and no cross-contamination occurs between the contaminated effluent and the sterilized effluent during the heat exchange,
pressurizing means to maintain a pressure in both the pressurized heating vessel and the second side of the heat exchanger that prevents boiling of the contaminated effluent and the sterilized effluent at the minimum temperature, and
an outlet for discharging the sterilized effluent.
